(19) United States
(12) Patent Application Publication
(10) Pub. No.: US 2007/0037910 A1
(43) Pub. Date: Feb. 15, 2007

(54) Polyolefin resin composition and combination of resin shaped bodies using same

(75) Inventor: Shigeru Murakami, Chiba (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Idemitsu Kosan Co., Ltd., TOKYO (JP)

(21) Appl. No.: 10/553,198

(22) PCT Filed: Apr. 13, 2004
(86) PCT No.: PCT/JP04/05247

§ 371 Date: Oct. 13, 2005

(30) Foreign Application Priority Data
Apr. 16, 2003 (JP) 2003-112094

(51) Int. Cl. C08K 5/13

(52) U.S. Cl. 524/323; 523/200; 524/543

(57) ABSTRACT

There are provided a polyolefin-based resin composition that is substantially prevented from suffering from oxidative deterioration of polyolefin resin and stably used even when positioned in contact with or near to vinyl chloride-based resins, as well as a combination of a vinyl-chloride-based resin molded article and a molded article made of the polyolefin-based resin composition. The polyolefin-based resin composition used in contact with or near to vinyl chloride-based resins, comprises (A) 100 parts by mass of a polyolefin-based resin; and (B) 0.01 to 5 parts by mass of a phenol-based antioxidant containing no aliphatic ester group and/or a sulfur-based antioxidant containing no aliphatic ester group, and may further contain, if required, 0.01 to 3 parts by mass of a metal deactivator containing no aliphatic ester, and 50 to 250 parts by mass of a metal hydrate and/or a metal hydroxide. In the combination of the vinyl-chloride-based resin molded article and the polyolefin-based molded article, both the molded articles are positioned in contact with or near to each other, and the polyolefin-based molded article is made of the above polyolefin-based resin composition.

### TECHNICAL FIELD

The present invention relates to a polyolefin-based resin composition that is excellent in environmental stability, etc., and more particularly to a stable polyolefin-based resin composition that is substantially prevented from suffering from deterioration in quality of resin, especially, even when used in contact with or near to vinyl chloride-based resins.

Further, the invention relates to a combination of a vinyl chloride-based resin molded article and a molded article made of the above polyolefin-based resin composition.

### BACKGROUND ARTS

At present, vinyl chloride-based resins have been extensively used in various applications because of excellent properties and low costs thereof, and more frequently used as covering or sheathing materials for electric wires or cables, interior materials for housing such as walls and floors, or the like. Currently, there is a demand for a huge number and a large amount of vinyl chloride-based resins. However, when recycling or disposing of the vinyl chloride-based resins after use, there might be such a probability that plasticizers contained therein and dioxin generated upon burning give adverse influences on human bodies and environment. For this reason, it has now been attempted to replace the vinyl chloride-based resins with polyolefin-based resin materials. In particular, such a tendency of replacement with polyolefin-based resins is more remarkable in domestic appliance and automobile makers. For example, composite materials made of polyolefin and metal hydrate have been increasingly used as covering or sheathing materials for electric wires or cables, i.e., as so-called eco-cables as well as tapes and tubes.

However, since the vinyl chloride-based resins are inexpensive and have a good flame retardancy in themselves as well as excellent mechanical properties, the vinyl chloride-based resins are inhibited from being fully replaced with polyolefin-based resin materials. As a result, the vinyl chloride-based resins and the polyolefin-based resins are presently used together either in contact with or near to each other.

Meanwhile, in the course of studies on improved polypropylene-based resin compositions, the present inventors have found that when a plurality of molded articles made of the same polyolefin-based resin composition using an ordinary phenol-based antioxidant in combination with an ordinary phosphorus-based antioxidant (refer to, for example, Japanese Patent Application Laid-open No. Sho 62-34934) were used in different places, a part thereof suffered from significant deterioration notwithstanding they were used under similar environmental conditions. As a result of seeking causes for such a phenomenon, the inventors have found that the polyolefin-based resin compositions used in contact with or extremely near to vinyl chloride-based resins underwent more severe deterioration than others. As a result of further studies on the deteriorated resin compositions, it has been found that the oxidative deterioration of the polyolefin-based resin is accelerated by plasticizers dissipated from the vinyl chloride-based resins or, in some cases, hydrogen chloride gas generated therefrom, when used under a relatively high temperature condition.

### DISCLOSURE OF THE INVENTION

A first object of the present invention is to provide a polyolefin-based resin composition, especially a polypropylene-based resin composition, which is substantially prevented from suffering from accelerated oxidative deterioration of the polyolefin resin when positioned in contact with or extremely near to vinyl chloride-based resins upon use, and which can be stably used even in contact with or near to the vinyl chloride-based resins.

A second object of the present invention is to provide a combination of a vinyl chloride-based resin molded article and a molded article made of the polyolefin-based resin composition having the above-described properties.

As a result of extensive researches in view of the above objects, the present inventors have found that when the specific antioxidant is selectively used together with polyolefin-based resins, accelerated deterioration of the polyolefin-based resins can be remarkably prevented even when used in contact with or near to vinyl chloride-based resins. The present invention has been accomplished on the basis of this finding.

Thus, the present invention provides:

(1) A polyolefin-based resin composition used in contact with or near to vinyl chloride-based resins, comprising:

(A) 100 parts by mass of a polyolefin-based resin; and

(B) 0.01 to 5 parts by mass of a phenol-based antioxidant containing no aliphatic ester group and/or a sulfur-based antioxidant containing no aliphatic ester group.

(2) A combination of a vinyl chloride-based resin molded article and a polyolefin-based resin molded article that are positioned in contact with or near to each other, said polyolefin-based resin molded article being made of a polyolefin-based resin composition comprising:

(A) 100 parts by mass of a polyolefin-based resin; and

(B) 0.01 to 5 parts by mass of a phenol-based antioxidant containing no aliphatic ester group and/or a sulfur-based antioxidant containing no aliphatic ester group.

(3) The polyolefin-based resin composition according to the above aspect (1), further comprising (C) a metal deactivator containing no aliphatic ester in an amount of 0.01 to 5 parts by mass based on 100 parts by mass of the polyolefin-based resin.

(4) The polyolefin-based resin composition according to the above aspect (1), further comprising (D) a metal hydrate and/or a metal hydroxide in an amount of 50 to 250 parts by mass based on 100 parts by mass of the polyolefin-based resin.

(5) The polyolefin-based resin composition according to the above aspect (1), wherein said phenol-based antioxidant (B) is at least one compound selected from the group consisting of:

(i) 2,6-di-t-butyl-4-methyl phenol;

(ii) a compound represented by the general formula (I): 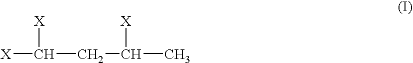
wherein X is a group represented by the general formula (II) with the proviso that the three X groups may be the same or different from each other: 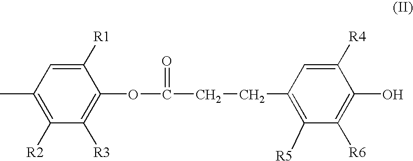
wherein R1 and R4 are independently C₁ to C₈ alkyl and may be the same or different from each other; and R2, R3, R5 and R6 are independently hydrogen or C₁ to C8 alkyl and may be the same or different from each other;

(iii) 1,3,5-trimethyl-2,4,6-tris(3,5-di-t-butyl-4-hydroxybenzyl)benzene;

(iv) tris(3,5-di-t-butyl-4-hydroxybenzyl)isocyanurate; and

(v) 4,4′-butylidenebis-(3-methyl-6-t-butylphenol).

(6) The polyolefin-based resin composition according to the above aspect (3), wherein said metal deactivator (C) containing no aliphatic ester is 1,2-bis(3,5-di-t-butyl-4-hydroxyhydrocinnamoyl)hydrazine.

(7) The polyolefin-based resin composition according to the above aspect (4), wherein said metal hydrate and/or said metal hydroxide (D) are magnesium hydroxide and/or aluminum hydroxide.

(8) A polyolefin-based resin composition used in contact with or near to vinyl chloride-based resins, comprising 100 parts by mass of polypropylene; 0.01 to 3 parts by mass of 1,2-bis(3,5-di-t-butyl-4-hydroxyhydrocinnamoyl)hydrazine, and 0.01 to 5 parts by mass of at least one antioxidant selected from the group consisting of:

(i) 2,6-di-t-butyl-4-methyl phenol;

(ii) 1,1,3-tris{2-methyl-4-[3-(3,5-di-t-butyl-4-hydroxyphenyl)propionyloxy]-5-t-butyl phenyl}butane;

(iii) 1,3,5-trimethyl-2,4,6-tris(3,5-di-t-butyl-4-hydroxybenzyl)benzene;

(iv) tris(3,5-di-t-butyl-4-hydroxybenzyl)isocyanurate; and

(v) 4,4′-butylidenebis-(3-methyl-6-t-butylphenol).

(9) A polyolefin-based resin composition used in contact with or near to vinyl chloride-based resins, comprising 100 parts by mass of polypropylene; 50 to 250 parts by mass of magnesium hydroxide; and 0.01 to 5 parts by mass of at least one antioxidant selected from the group consisting of:

(i) 2,6-di-t-butyl-4-methyl phenol;

(ii) 1,1,3-tris{2-methyl-4-[3-(3,5-di-t-butyl-4-hydroxyphenyl)propionyloxy]-5-t-butyl phenyl}butane;

(iii) 1,3,5-trimethyl-2,4,6-tris(3,5-di-t-butyl-4-hydroxybenzyl)benzene;

(iv) tris(3,5-di-t-butyl-4-hydroxybenzyl)isocyanurate; and

(v) 4,4′-butylidenebis-(3-methyl-6-t-butylphenol).

(10) The combination according to the above aspect (2), wherein said vinyl chloride-based resin molded article is enclosed in said polyolefin-based resin molded article.

(11) The combination according to the above aspect (2), wherein said polyolefin-based resin molded article is enclosed in said vinyl chloride-based resin molded article.

(12) The combination according to the above aspect (2), wherein a layer made of said vinyl chloride-based resin molded article and a layer made of said polyolefin-based resin molded article are directly or indirectly laminated on each other.

(13) The combination according to the above aspect (2), wherein said polyolefin-based resin composition further comprises (C) a metal deactivator containing no aliphatic ester in an amount of 0.01 to 5 parts by mass based on 100 parts by mass of the polyolefin-based resin.

(14) The combination according to the above aspect (2), wherein said polyolefin-based resin composition further comprises (D) a metal hydrate and/or a metal hydroxide in an amount of 50 to 250 parts by mass based on 100 parts by mass of the polyolefin-based resin.

(15) The combination according to the above aspect (2), wherein said phenol-based antioxidant (B) is at least one compound selected from the group consisting of:

(i) 2,6-di-t-butyl-4-methyl phenol;

(ii) a compound represented by the general formula (I): 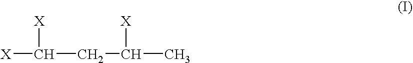
wherein X is a group represented by the general formula (II) with the proviso that the three X groups may be the same or different from each other: 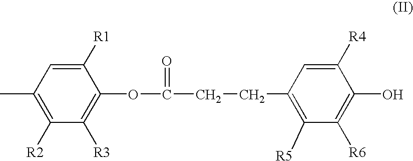
wherein R1 and R4 are independently C₁ to C₈ alkyl and may be the same or different from each other; and R2, R3, R5 and R6 are independently hydrogen or C₁ to C₈ alkyl and may be the same or different from each other;

(iii) 1,3,5-trimethyl-2,4,6-tris(3,5-di-t-butyl-4-hydroxybenzyl)benzene;

(iv) tris(3,5-di-t-butyl-4-hydroxybenzyl)isocyanurate; and

(v) 4,4′-butylidenebis-(3-methyl-6-t-butylphenol).

(16) The combination according to the above aspect (13), wherein said metal deactivator (C) containing no aliphatic ester is 1,2-bis(3,5-di-t-butyl-4-hydroxyhydrocinnamoyl)hydrazine.

(17) The combination according to the above aspect (14), wherein said metal hydrate and/or said metal hydroxide (D) are magnesium hydroxide and/or aluminum hydroxide.

(18) A combination of a vinyl chloride-based resin molded article and a polyolefin-based resin molded article that are positioned in contact with or near to each other, said polyolefin-based resin molded article being made of a polyolefin-based resin composition comprising 100 parts by mass of polypropylene; 0.01 to 3 parts by mass of 1,2-bis(3,5-di-t-butyl-4-hydroxyhydrocinnamoyl)hydrazine; and 0.01 to 5 parts by mass of at least one antioxidant selected from the group consisting of:

(i) 2,6-di-t-butyl-4-methyl phenol;

(ii) 1,1,3-tris{2-methyl-4-[3-(3,5-di-t-butyl-4-hydroxyphenyl)propionyloxy]-5-t-butyl phenyl}butane;

(iii) 1,3,5-trimethyl-2,4,6-tris(3,5-di-t-butyl-4-hydroxybenzyl)benzene;

(iv) tris(3,5-di-t-butyl-4-hydroxybenzyl)isocyanurate; and

(v) 4,4′-butylidenebis-(3-methyl-6-t-butylphenol).

(19) A combination of a vinyl chloride-based resin molded article and a polyolefin-based resin molded article that are positioned in contact with or near to each other, said polyolefin-based resin molded article being made of a polyolefin-based resin composition comprising 100 parts by mass of polypropylene; 50 to 250 parts by mass of magnesium hydroxide; and 0.01 to 5 parts by mass of at least one antioxidant selected from the group consisting of:

(i) 2,6-di-t-butyl-4-methyl phenol;

(ii) 1,1,3-tris{2-methyl-4-[3-(3,5-di-t-butyl-4-hydroxyphenyl)propionyloxy]-5-t-butyl phenyl}butane;

(iii) 1,3,5-trimethyl-2,4,6-tris(3,5-di-t-butyl-4-hydroxybenzyl)benzene;

(iv) tris(3,5-di-t-butyl-4-hydroxybenzyl)isocyanurate; and

(v) 4,4′-butylidenebis-(3-methyl-6-t-butylphenol).

As described above, when a polyolefin-based resin is used together with a phenol-based antioxidant containing no aliphatic ester group and/or a sulfur-based antioxidant containing no aliphatic ester group, and further blended, if required, with a metal deactivator and a metal hydrate and/or metal hydroxide, the resultant polyolefin-based resin composition can be remarkably prevented from suffering from oxidative deterioration of the polyolefin-based resin, etc., even when used in contact with or near to vinyl chloride-based resins.

### PREFERRED EMBODIMENT TO CARRY OUT THE INVENTION

The present invention is described in detail below.

Examples of the polyolefin-based resin usable in the present invention include poly-a-olefin resins such as low-density polyethylene, linear low-density polyethylene, medium-density polyethylene, high-density polyethylene, polypropylene, ethylene-propylene random copolymer, ethylene-propylene block copolymer, polybutene-1, ethylene-butene-1 random copolymer and polymethylpentene-1; copolymer of poly-α-olefin with vinyl monomer such as maleic anhydride-modified polypropylene; and mixtures thereof. Of these resins, preferred are polypropylene-based resin, and more preferred are ethylene-propylene block copolymer.

Specific examples of the vinyl chloride-based resins that can be effectively used together with the polyolefin-based resin composition of the present invention include polyvinyl chloride, vinyl chloride-vinyl acetate copolymer, vinyl chloride-alkyl acrylate copolymer, vinyl chloride-vinylidene chloride copolymer, chlorinated polyethylene, or the like.

The polyolefin-based resin composition of the present invention can show a more remarkable effect of preventing deterioration of the polyolefin-based resin when used together with vinyl chloride-based resins containing plasticizers, as compared to the conventional antioxidant-formulated polyolefin-based resin compositions.

Examples of the plasticizers include phthalic acid ester, phosphoric acid ester, aliphatic acid ester, chlorinated paraffin, trimellitic acid ester, epoxidated vegetable oil, pyromelltic acid ester, polyester or the like. These plasticizers are contained in an amount of 20 to 150 parts by mass and preferably 30 to 100 parts by mass based on 100 parts by mass of the vinyl chloride-based resin.

The wording “near to vinyl-chloride-based resins” used herein means that the polyolefin-based resin composition is disposed at such a distance that the plasticizers contained in the vinyl chloride-based resins or hydrogen chloride produced by partial decomposition of the vinyl-chloride-based resin can reach or come into contact with the polyolefin-based resin (A) by migration, evaporation or diffusion, filling or the like.

The distance between the polyolefin-based resin composition and the vinyl chloride-based resins is usually 1 cm or smaller. However, in the case where the polyolefin-based resin molded article is surrounded by the vinyl chloride-based resin-containing molded article such as housings, covers and boxes, or vice versa, the above plasticizers or hydrogen chloride may reach or come into contact with the polyolefin-based resin (A) by migration, evaporation or diffusion, filling or the like even though the distance therebetween is slightly larger, e.g., 50 cm or less.

Further, in the case where both the molded articles are placed at such a position where the temperature tends to increase to 50° C. or higher, the above plasticizers or hydrogen chloride may also reach or come into contact with the polyolefin-based resin (A) by migration, evaporation or diffusion, filling or the like. Therefore, even when these molded articles are spaced from each other at a slightly larger distance, for example, 50 cm or less, the above cases are considered to correspond to the condition of “near to vinyl chloride-based resins”.

The antioxidant usable in the present invention is not limited to particular ones as long as it is composed of a phenol-based antioxidant containing no aliphatic ester group and/or a sulfur-based antioxidant containing no aliphatic ester group.

Of these antioxidants, the phenol-based antioxidant containing no aliphatic ester group is preferably at least one compound selected from the group consisting of the following compounds (i) to (v):

(i) 2,6-di-t-butyl-4-methyl phenol;

(ii) a compound represented by the general formula (I): 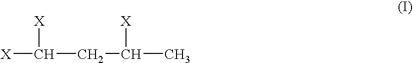
wherein X is a group represented by the general formula (II) with the proviso that the three X groups may be the same or different from each other: 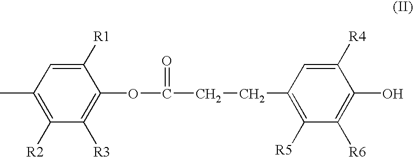
wherein R1 and R4 are independently C₁ to C₈ alkyl and may be the same or different from each other; and R2, R3, R5 and R6 are independently hydrogen or C₁ to C₈ alkyl and may be the same or different from each other;

(iii) 1,3,5-trimethyl-2,4,6-tris(3,5-di-t-butyl-4-hydroxybenzyl)benzene;

(iv) tris(3,5-di-t-butyl-4-hydroxybenzyl)isocyanurate; and

(v) 4,4′-butylidenebis-(3-methyl-6-t-butylphenol).

Of these antioxidants, preferred are compounds represented by the above general formula (I), and more preferred is 1,1,3-tris{2-methyl-4-[3-(3,5-di-t-butyl-4-hydroxyphenyl)propionyloxy]-5-t-butyl phenyl}butane (tradename: “GSY-242” available from A. P. I. Corporation; CAS Registry No. 180002-86-2).

In the general formula (II), R1 and R4 are independently C₁, to C₈ alkyl and may be the same or different from each other. Specific examples of the C₁ to C₈ alkyl group include linear, branched or cyclic alkyl groups such as methyl, ethyl, n-propyl, isopropyl, n-butyl, isobutyl, sec-butyl, tert-butyl, n-pentyl, isopentyl, sec-pentyl, tert-pentyl, 2-methylbutyl, n-hexyl, isohexyl, sec-hexyl, tert-hexyl, cyclohexyl, heptyl, n-octyl, isooctyl, sec-octyl, tert-octyl and 2-ethylhexyl. Of these alkyl groups, preferred are C₁ to C₅ alkyl groups, and more preferred is tert-butyl.

In the general formula (II), R2, R3, R5 and R6 are independently hydrogen or C₁ to C₈ alkyl and may be the same or different from each other. Specific examples of the C₁ to C₈ alkyl group include linear, branched or cyclic alkyl groups such as methyl, ethyl, n-propyl, isopropyl, n-butyl, isobutyl, sec-butyl, tert-butyl, n-pentyl, isopentyl, sec-pentyl, tert-pentyl, 2-methylbutyl, n-hexyl, isohexyl, sec-hexyl, tert-hexyl, cyclohexyl, heptyl, n-octyl, isooctyl, sec-octyl, tert-octyl and 2-ethylhexyl. Of these alkyl groups, preferred are C₁ to C₅ alkyl groups. More preferably, R2 and R3 are respectively hydrogen or methyl, R5 is hydrogen, and R5 is tert-butyl.

As the sulfur-based antioxidant containing no aliphatic ester group, there may be used bis(2-methyl-4-(3-n-alkylthiopropionyloxy)-5-tert-butylphenyl)sulfide (tradename: AO-23 available from Asahi Denka Co., Ltd.) or the like.

The phenol-based antioxidant containing no aliphatic ester group and/or the sulfur-based antioxidant containing no aliphatic ester group (B) are blended in an amount of 0.01 to 5 parts by mass, preferably 0.1 to 3 parts by mass and more preferably 0.2 to 2 parts by mass based on 100 parts by mass of the polyolefin-based resin.

When the amount of the antioxidant blended is less than 0.01 part by mass, substantially no anti-oxidizing effect is exhibited. When the amount of the antioxidant blended exceeds 3 parts by mass, the increase in anti-oxidizing effect corresponding to such a large amount of the antioxidant used is not attainable, and rather problems such as bleeding tend to occur.

The antioxidant used in the present invention is required to include an antioxidant containing no aliphatic ester group. The use of antioxidants containing an aliphatic ester group in a molecule thereof, for example, tetrakis[methylene-3-(3,5-di-t-butyl-4-hydroxyphenyl)propionate]methane (tradename: “IRGANOX 1010” available from Ciba Specialty Chemicals, Corp.) or n-octadecyl-3-(3′,5′-di-t-butyl-4′-hydroxyphenyl)propionate (tradename: “IRGANOX 1076” available from Ciba Specialty Chemicals, Corp.) as well as other various sulfur-based antioxidants containing an aliphatic ester group in a molecule thereof is ineffective for the objects of the present invention unless these aliphatic ester group-containing antioxidants are used in combination with the antioxidants defined in the present invention.

Namely, if the phenol-based and/or sulfur-based antioxidants containing an aliphatic ester group in a molecule thereof or phosphorus-based antioxidants are used alone in resin members disposed in contact with or near to vinyl chloride-based resins, the anti-oxidizing effect is not sufficiently exhibited, thereby causing such a risk that the resin members are worn out.

The polyolefin-based resin composition of the present invention used, for example, as a covering or sheathing material for electric wires or cables as well as a tube and a tape, tends to be disposed not only in contact with or near to the vinyl chloride-based resins but also in contact with copper-containing materials. When the polyolefin-based resin composition is used in contact with the materials containing a metal such as copper, a metal deactivator such as a copper inhibitor (C) containing no aliphatic ester is preferably blended in the composition.

Examples of the preferred copper inhibitor include 1,2-bis(3,5-di-t-butyl-4-hydroxyhydrocinnamoyl)hydrazine (trade name: “IRGANOX MD 1024” available from Ciba Specialty Chemicals Corp.) or the like.

The metal deactivator is blended in an amount of 0.01 to 5 parts by mass, preferably 0.03 to 2 parts by mass and more preferably 0.05 to 1 part by mass based on 100 parts by mass of the polyolefin-based resin. When the amount of the metal deactivator blended is less than 0.01 part by mass, the metal deactivator exhibits substantially no effect. When the amount of the metal deactivator blended exceeds 3 parts by mass, an increased effect corresponding to such a large amount of the metal deactivator used is not attainable, and rather problems such as bleeding tend to occur. When a metal deactivator containing an aliphatic ester is used in resin members disposed in contact with or near to vinyl chloride-based resins, both the antioxidants and the metal deactivator fail to exhibit their sufficient effects, so that the resin members tend to be worn out owing to accelerated deterioration thereof.

The polyolefin-based resin composition of the present invention may also contain a metal hydrate and/or metal hydroxide (D) in order to improve a flame retardancy thereof. Examples of the metal hydrate and/or metal hydroxide (D) include magnesium hydroxide, aluminum hydroxide, hydrotalcite or the like. Of these compounds, preferred is magnesium hydroxide, and more preferred is magnesium hydroxide having a particle size of 2 μm or less which is surface-coated with fatty acids, silane coupling agents or the like. The metal hydrate and/or metal hydroxide (D) is blended in an amount of 50 to 250 parts by mass and preferably 60 to 200 parts by mass based on 100 parts by mass of the polyolefin-based resin. When the amount of the metal hydrate and/or metal hydroxide (D) blended per 100 parts by mass of the polyolefin-based resin is less than 50 parts by mass, it is difficult to use the resultant resin composition in such applications requiring a especially high flame retardancy, such as covering or sheathing materials for electric wires or cables. When the amount of the metal hydrate and/or metal hydroxide (D) blended exceeds 250 parts by mass, it is also difficult to apply the resin composition to covering or sheathing materials for electric wires or cables owing to too high hardness thereof, and further the obtained resin composition tends to be deteriorated in moldability and appearance.

One of specific examples of the polyolefin-based resin composition which is formulated by blending the above respective components with each other, is as follows:

(A) Polypropylene 100 parts by mass

(B) At least one antioxidant selected from the group consisting of the following compounds (i) to (v): 0.01 to 5 parts by mass
(i) 2,6-di-t-butyl-4-methyl phenol;
(ii) 1,1,3-tris{2-methyl-4-[3-(3,5-di-t-butyl-4-hydroxyphenyl)propionyloxy]-5-t-butyl phenyl}butane;
(iii) 1,3,5-trimethyl-2,4,6-tris(3,5-di-t-butyl-4-hydroxybenzyl)benzene;
(iv) tris(3,5-di-t-butyl-4-hydroxybenzyl)isocyanurate; and
(v) 4,4′-butylidenebis-(3-methyl-6-t-butylphenol)

(C) 1,2-bis(3,5-di-t-butyl-4-hydroxyhydrocinnamoyl)hydrazine 0.01 to 3 parts by mass

(D) Magnesium hydroxide 50 to 250 parts by mass

The thus prepared polyolefin-based resin composition can exhibit not only a sufficient anti-oxidizing effect even when applied to members disposed in contact with or near to the vinyl chloride-based resins, but also a good flame retardancy with less problems such as generation of dioxin as compared to that of the vinyl chloride-based resins.

The polyolefin-based resin composition of the present invention may further contain, if required, various fillers and additives unless the addition of these fillers and additives adversely affects the objects of the present invention.

Examples of the fillers include inorganic fillers such as calcium carbonate, talc, glass fibers, mica, whiskers and clays, or the like. Examples of the additives include antioxidants, carbon black, lubricants, ultraviolet absorbers, weather-proofing agents such as light stabilizers, pigments, silicone-based polymers, ultrahigh-molecular polyethylene or the like. These fillers or additives may be blended in an amount of 0.1 to 20 parts by mass based on 100 parts by mass of the polyolefin-based resin.

Further, when the polyolefin-based resin composition of the present invention should be formulated especially so as to exhibit a non-halogen-based flame retardancy, the resin composition may also contain, for example, elastomers modified with carboxylic anhydrides or derivatives thereof, thermoplastic elastomers such as styrene-based hydrogenated polymers, or the like.

The polyolefin-based resin composition of the present invention can more sufficiently exhibit its properties when used as a material for molded articles disposed in contact with or near to vinyl chloride-based resins.

Examples of the combination of a molded article containing the polyolefin-based resin composition of the present invention (hereinafter occasionally referred to as a “polyolefin-based resin molded article”) and a vinyl chloride-based resin molded article (polyolefin-based resin molded article/vinyl chloride-based resin molded article) include covering or sheathing material for electric wires or cables/tape for bundling electric wires or cables; covering or sheathing material for electric wires or cables/cover or housing for surrounding bundles of electric wires or cables; covering or sheathing material for electric wires or cables/covering or sheathing material for electric wires or cables; and vice versa in their materials.

That is, according to the second aspect of the present invention, there is provided a combination of a vinyl chloride-based resin molded article and a polyolefin-based resin molded article in which both the molded articles are positioned in contact with or near to each other, and the polyolefin-based resin composition comprises (A) 100 parts by mass of a polyolefin-based resin; and (B) 0.01 to 5 parts by mass of a phenol-based antioxidant containing no aliphatic ester group and/or a sulfur-based antioxidant containing no aliphatic ester group. All of the definitions and requirements described as to the polyolefin-based resin composition according to the first aspect of the present invention are involved in the second aspect of the present invention.

Further, the second aspect of the present invention includes the following specific embodiments:

(1) Combination as defined in claim 2 wherein the vinyl chloride-based resin molded article is enclosed in the polyolefin-based resin molded article;

(2) Combination as defined in claim 2 wherein the polyolefin-based resin molded article is enclosed in the vinyl chloride-based resin molded article; and

(3) Combination as defined in claim 2 wherein a layer made of the vinyl chloride-based resin molded article and a layer made of the polyolefin-based resin molded article are directly or indirectly laminated on each other.

### EXAMPLES

A mixture prepared by blending respective components for resin compositions with each other at a mixing ratio as shown in Tables 1 and 2, was melt-kneaded using a twin-screw kneader “TEM35” available from Toshiba Kikai Co., Ltd., to obtain pellets having various resin compositions. The thus obtained pellets were formed into a 2 mm-thick dumbbell-shaped test specimen using an injection-molding machine. A commercially available vinyl chloride adhesive tape was attached to a central portion of the dumbbell-shaped test specimen, and allowed to stand in an oven maintained at 140° C. After the elapse of a predetermined time as shown in Table 1 or 2, the respective test specimens were taken out of the oven, and subjected to tensile test according to JIS K 7162 to measure a tensile strength and an elongation thereof. Meanwhile, the elongation of the respective test specimens before the heat treatment was similarly measured to calculate an elongation retention according to the following formula:
Elongation Retention =[(L−M)/L]×100(%)
wherein L is an elongation (mm) of the test specimen before the heat treatment; and M is an elongation (mm) of the test specimen after the heat treatment.

The elongation retention is an index indicating a degree of deterioration.

The test specimen solely (without attachment of a vinyl chloride adhesive tape) as a control sample was allowed to stand in a separate oven maintained at 140° C. After the elapse of the predetermined time as shown in Table 1 or 2, the test specimen was taken out of the oven, and similarly subjected to tensile test according to JIS K 7162, and the elongation retention was similarly determined. The results of these measurements are shown in Tables 1 and 2.

Meanwhile, the polyolefin-based resin compositions shown in Table 1 are those for natural materials, and the polyolefin-based resin compositions shown in Table 2 are those for non-halogen flame retardant formulation.

TABLE 1
Natural Products
Composition and Measurement Results

| | | | | | | Comparative | |
|---|---|---|---|---|---|---|---|
| | | Examples | | | | Examples | |
| | Component | 1 | 2 | 3 | 4 | 1 | 2 |
| Polyolefin | J-466HP | 100 | 100 | 100 | 100 | 100 | 100 |
| Phenol-based | GSY-242 | 0.5 | 0 | 0 | 0 | 0 | 0 |
| antioxidant | Irg-1330 | 0 | 0.5 | 0 | 0 | 0 | 0 |
| | AO-20 | 0 | 0 | 0.5 | 0 | 0 | 0 |
| | BHT | 0 | 0 | 0 | 0.2 | 0 | 0 |
| | Irg-1010 | 0 | 0 | 0 | 0 | 0.5 | 0 |
| Sulfur-based | SUMILIZER-TPL | 0 | 0 | 0 | 0 | 0 | 0.5 |
| antioxidant | | | | | | | |
| Tensile yield stress (MPa) | | 20 | 20 | 20 | 20 | 20 | 21 |
| Tensile stress at break (MPa) | | 32 | 32 | 32 | 32 | 32 | 32 |
| Tensile elongation at break (%) | | 400 | 420 | 400 | 410 | 380 | 410 |
| Tensile modulus (MPa) | | 1140 | 1150 | 1110 | 1140 | 1130 | 1150 |
| Elongation | after 144 hr | 71 | 69 | 66 | 68 | 37 | 54 |
| retention | after 336 hr | 49 | 44 | 50 | 45 | 4 | 3 |
| (at 140°) | after 480 hr | 10 | 8 | 7 | 2 | — | — |
| (%) | after 480 hr without | 49 | 52 | 54 | 55 | 66 | 63 |
| | vinyl chloride tape | | | | | | |

TABLE 2
Non-Halogen Formulation Products
Composition and Measurement Results

| | | | | | Comparative | |
|---|---|---|---|---|---|---|
| | | Examples | | | Examples | |
| | Component | 5 | 6 | 7 | 3 | 4 |
| Polyolefin | J-466HP | 11 | 11 | 11 | 11 | 11 |
| | MR110M | 5 | 5 | 5 | 5 | 5 |
| | AD89G | 5 | 5 | 5 | 5 | 5 |
| | M142E | 35 | 35 | 35 | 35 | 35 |
| Phenol-based | GSY-242 | 0.5 | 0 | 0 | 0 | 0 |
| antioxidant | Irg-1330 | 0 | 0.5 | 0 | 0 | 0 |
| | AO-20 | 0 | 0 | 0.5 | 0 | 0 |
| | Irg-1010 | 0 | 0 | 0 | 0.4 | 0.4 |
| Phosphorus-based | Irg-168 | 0 | 0 | 0 | 0.2 | 0.2 |
| antioxidant | | | | | | |
| Metal | MD1024 | 0.2 | 0.2 | 0.2 | 0 | 0 |
| deactivator | CDA-1 | 0 | 0 | 0 | 0.3 | 0 |
| | NOWGAURD XD-L | 0 | 0 | 0 | 0 | 0.2 |
| Flame | Mg hydroxide | 40 | 40 | 40 | 40 | 40 |
| retardant | | | | | | |
| Silicone | BY27-001 | 4 | 4 | 4 | 4 | 4 |
| polymer | | | | | | |
| Tensile stress at break (MPa) | | 18.1 | 19.0 | 19.0 | 15.6 | 18.0 |
| Tensile elongation at break (%) | | 170 | 200 | 200 | 210 | 190 |
| Tensile modulus (MPa) | | 325 | 295 | 295 | 284 | 316 |
| Elongation | after 68 hr on | 64.7 | 60.0 | 60.0 | 52.4 | 57.9 |
| retention | copper | | | | | |
| (at 140°) | after 221 hr on | 64.7 | 55.0 | 55.0 | 10.5* | 57.9 |
| (%) | copper | | | | | |
| | after 384 hr on | 51.8 | 55.0** | 55.0** | 0.0*** | 15.0* |
| | copper | | | | | |
| | after 384 hr on | 55.9 | 50.0 | 50.0 | 14.0 | 25.0 |
| | aluminum with | | | | | |
| | vinyl chloride | | | | | |
| | tape | | | | | |
| | after 384 hr on | 53.5 | 50.0 | 50.0 | 48.0 | 52.6 |
| | aluminum | | | | | |
| | without vinyl | | | | | |
| | chloride tape | | | | | |

Note:
*Somewhat discolored;
**Slightly discolored;
***Worn out

Meanwhile, the symbols of the respective components as shown in Tables represent the followings:

(A) Polyolefin-Based Resin:

J-466HP: Block polypropylene available from Idemitsu Petrochemical Co., Ltd.

M110 B (formerly named as MR110M): Maleic acid-modified thermoplastic elastomer available from Idemitsu Petrochemical Co., Ltd.

AD89G: Maleic acid-modified polypropylene available from Idemitsu Petrochemical Co., Ltd.

M142E: Thermoplastic elastomer available from Idemitsu Petrochemical Co., Ltd.

(B) Antioxidant:

Phenol-Based Antioxidant Containing No Aliphatic Ester Group

GSY-242: 1,1,3-tris{2-methyl-4-[3-(3,5-di-t-butyl-4-hydroxyphenyl)propionyloxy]-5-t-butyl phenyl}butane available from A. P. I. Corporation

Irg-1330: 1,3,5-trimethyl-2,4,6-tris(3,5-di-t-butyl-4-hydroxybenzyl)benzene available from Ciba Specialty Chemicals, Corp.

AO-20: tris(3,5-di-t-butyl-4-hydroxybenzyl)isocyanurate available from Asahi Denka Kogyo Co., Ltd.

BHT: 2,6-di-t-butyl-4-methyl phenol available from Sumitomo Chemical Co., Ltd.

Phenol-Based Antioxidant Containing an Aliphatic Ester Group

Irg-1010: tetrakis[methylene-3-(3,5-di-t-butyl-4-hydroxyphenyl)propionate]methane available from Ciba Specialty Chemicals, Corp.

Phosphorus-Based Antioxidant

Irg-168: tris(2,4-di-t-butylphenyl)phosphite available from Ciba Specialty Chemicals, Corp.

Sulfur-Based Antioxidant

SUMILIZER-TPL: dilauryl-3,3′-thiopropionate available from Sumitomo Chemical Co., Ltd.

(C) Metal Deactivator (Copper Inhibitor):

MD 1024: 1,2-bis(3,5-di-t-butyl-4-hydroxyhydrocinnamoyl)hydrazine available from Ciba Specialty Chemicals, Corp.: IRGANOX MD1024

CDA-1: 3-(N-salicyloyl)amino-1,2,4-triazole available from Asahi Denka Kogyo Co., Ltd.

NOWGUARD XD-L: 2,2′-oxalyl diamide bis(ethyl-3-(3,5-di-t-butyl-4-hydroxyphenyl)propionate available from Uniroyal Chemical Co., Inc.

(E) Other Additives:

BY27-001: Silicone polymer available from Toray Dow Corning Silicone Co., Ltd.

As is apparent from the results of elongation retention shown in Tables 1 and 2, it was confirmed that the polypropylene resin compositions of the present invention exhibited a good stability. As shown in Table 1, the polypropylene resin compositions of the present invention still maintained an almost good elongation retention even after the elapse of 336 hours, whereas those of Comparative Examples using no antioxidant according to the present invention were rapidly deteriorated in elongation retention. Further, in Table 2, there are shown results of a stability test for the resin compositions further containing a metal deactivator which test was conducted under such a condition contacting with copper . As shown in Table 2, the polypropylene resin compositions of the present invention showed a good elongation retention even after the elapse of 221 hours, and were merely slightly discolored even after the elapse of 384 hours, whereas those of Comparative Examples using neither antioxidant nor metal deactivator according to the present invention were rapidly deteriorated in elongation retention, and were significantly discolored or worn out.

### INDUSTRIAL APPLICABILITY

The polyolefin-based resin composition containing a specific phenol-based antioxidant containing no aliphatic ester group and/or a specific sulfur-based antioxidant containing no aliphatic ester group according to the present invention can exhibit a sufficient anti-oxidizing effect even when used in contact with or near to vinyl chloride-based resins, and can be remarkably inhibited from suffering from deterioration due to the existence of the vinyl chloride-based resins.

1. A polyolefin-based resin composition used in contact with or near to vinyl chloride-based resins, comprising:
(A) 100 parts by mass of a polyolefin-based resin; and
(B) 0.01 to 5 parts by mass of a phenol-based antioxidant containing no aliphatic ester group and/or a sulfur-based antioxidant containing no aliphatic ester group.

2. A combination of a vinyl chloride-based resin molded article and a polyolefin-based resin molded article that are positioned in contact with or near to each other, said polyolefin-based resin molded article being made of a polyolefin-based resin composition comprising:
(A) 100 parts by mass of a polyolefin-based resin; and
(B) 0.01 to 5 parts by mass of a phenol-based antioxidant containing no aliphatic ester group and/or a sulfur-based antioxidant containing no aliphatic ester group.

3. The polyolefin-based resin composition according to claim 1, further comprising (C) a metal deactivator containing no aliphatic ester in an amount of 0.01 to 5 parts by mass based on 100 parts by mass of the polyolefin-based resin.

4. The polyolefin-based resin composition according to claim 1, further comprising (D) a metal hydrate and/or a metal hydroxide in an amount of 50 to 250 parts by mass based on 100 parts by mass of the polyolefin-based resin.

5. The polyolefin-based resin composition according to claim 1, wherein said phenol-based antioxidant (B) is at least one compound selected from the group consisting of:
(i) 2,6-di-t-butyl-4-methyl phenol;
(ii) a compound represented by the general formula (I): 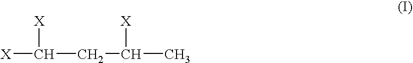
wherein X is a group represented by the general formula (II) with the proviso that the three X groups may be the same or different from each other: 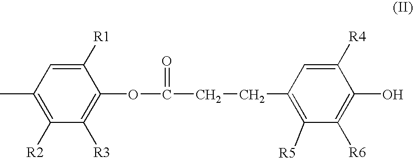
wherein R1 and R4 are independently C₁ to C₈ alkyl and may be the same or different from each other; and R2, R3, R5 and R6 are independently hydrogen or C₁ to C₈ alkyl and may be the same or different from each other;
(iii) 1,3,5-trimethyl-2,4,6-tris(3,5-di-t-butyl-4-hydroxybenzyl)benzene;
(iv) tris(3,5-di-t-butyl-4-hydroxybenzyl)isocyanurate; and
(v) 4,4′-butylidenebis-(3-methyl-6-t-butylphenol).

6. The polyolefin-based resin composition according to claim 3, wherein said metal deactivator (C) containing no aliphatic ester is 1,2-bis(3,5-di-t-butyl-4-hydroxyhydrocinnamoyl)hydrazine.

7. The polyolefin-based resin composition according to claim 4, wherein said metal hydrate and/or said metal hydroxide (D) are magnesium hydroxide and/or aluminum hydroxide.

8. A polyolefin-based resin composition used in contact with or near to vinyl chloride-based resins, comprising 100 parts by mass of polypropylene; 0.01 to 3 parts by mass of 1,2-bis(3,5-di-t-butyl-4-hydroxyhydrocinnamoyl)hydrazine, and 0.01 to 5 parts by mass of at least one antioxidant selected from the group consisting of:
(i) 2,6-di-t-butyl-4-methyl phenol;
(ii) 1,1,3-tris{2-methyl-4-[3-(3,5-di-t-butyl-4-hydroxyphenyl)propionyloxy]-5-t-butyl phenyl}butane;
(iii) 1,3,5-trimethyl-2,4,6-tris(3,5-di-t-butyl-4-hydroxybenzyl)benzene;
(iv) tris(3,5-di-t-butyl-4-hydroxybenzyl)isocyanurate; and
(v) 4,4′-butylidenebis-(3-methyl-6-t-butylphenol).

9. A polyolefin-based resin composition used in contact with or near to vinyl chloride-based resins, comprising 100 parts by mass of polypropylene; 50 to 250 parts by mass of magnesium hydroxide; and 0.01 to 5 parts by mass of at least one antioxidant selected from the group consisting of:
(i) 2,6-di-t-butyl-4-methyl phenol;
(ii) 1,1,3-tris{2-methyl-4-[3-(3,5-di-t-butyl-4-hydroxyphenyl)propionyloxy]-5-t-butyl phenyl}butane;
(iii) 1,3,5-trimethyl-2,4,6-tris(3,5-di-t-butyl-4-hydroxybenzyl)benzene;
(iv) tris(3,5-di-t-butyl-4-hydroxybenzyl)isocyanurate; and
(v) 4,4′-butylidenebis-(3-methyl-6-t-butylphenol).

10. The combination according to claim 2, wherein said vinyl chloride-based resin molded article is enclosed in said polyolefin-based resin molded article.

11. The combination according to claim 2, wherein said polyolefin-based resin molded article is enclosed in said vinyl chloride-based resin molded article.

12. The combination according to claim 2, wherein a layer made of said vinyl chloride-based resin molded article and a layer made of said polyolefin-based resin molded article are directly or indirectly laminated on each other.

13. The combination according to claim 2, wherein said polyolefin-based resin composition further comprises (C) a metal deactivator containing no aliphatic ester in an amount of 0.01 to 5 parts by mass based on 100 parts by mass of the polyolefin-based resin.

14. The combination according to claim 2, wherein said polyolefin-based resin composition further comprises (D) a metal hydrate and/or a metal hydroxide in an amount of 50 to 250 parts by mass based on 100 parts by mass of the polyolefin-based resin.

15. The combination according to claim 2, wherein said phenol-based antioxidant (B) is at least one compound selected from the group consisting of:
(i) 2,6-di-t-butyl-4-methyl phenol;
(ii) a compound represented by the general formula (I): 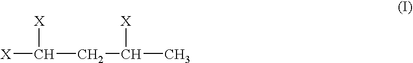
wherein X is a group represented by the general formula (II) with the proviso that the three X groups may be the same or different from each other: 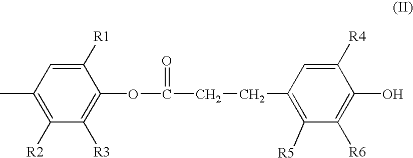
wherein R1 and R4 are independently C₁ to C₈ alkyl and may be the same or different from each other; and R2, R3, R5 and R6 are independently hydrogen or C₁ to C₈ alkyl and may be the same or different from each other;
(iii) 1,3,5-trimethyl-2,4,6-tris(3,5-di-t-butyl-4-hydroxybenzyl)benzene;
(iv) tris(3,5-di-t-butyl-4-hydroxybenzyl)isocyanurate; and
(v) 4,4′-butylidenebis-(3-methyl-6-t-butylphenol).

16. The combination according to claim 13, wherein said metal deactivator (C) containing no aliphatic ester is 1,2-bis(3,5-di-t-butyl-4-hydroxyhydrocinnamoyl)hydrazine.

17. The combination according to claim 14, wherein said metal hydrate and/or said metal hydroxide (D) are magnesium hydroxide and/or aluminum hydroxide.

18. A combination of a vinyl chloride-based resin molded article and a polyolefin-based resin molded article that are positioned in contact with or near to each other, said polyolefin-based resin molded article being made of a polyolefin-based resin composition comprising 100 parts by mass of polypropylene; 0.01 to 3 parts by mass of 1,2-bis(3,5-di-t-butyl-4-hydroxyhydrocinnamoyl)hydrazine; and 0.01 to 5 parts by mass of at least one antioxidant selected from the group consisting of:
(i) 2,6-di-t-butyl-4-methyl phenol;
(ii) 1,1,3-tris{2-methyl-4-[3-(3,5-di-t-butyl-4-hydroxyphenyl)propionyloxy]-5-t-butyl phenyl}butane;
(iii) 1,3,5-trimethyl-2,4,6-tris(3,5-di-t-butyl-4-hydroxybenzyl)benzene;
(iv) tris(3,5-di-t-butyl-4-hydroxybenzyl)isocyanurate; and
(v) 4,4′-butylidenebis-(3-methyl-6-t-butylphenol).

19. A combination of a vinyl chloride-based resin molded article and a polyolefin-based resin molded article that are positioned in contact with or near to each other, said polyolefin-based resin molded article being made of a polyolefin-based resin composition comprising 100 parts by mass of polypropylene; 50 to 250 parts by mass of magnesium hydroxide; and 0.01 to 5 parts by mass of at least one antioxidant selected from the group consisting of:
(i) 2,6-di-t-butyl-4-methyl phenol;
(ii) 1,1,3-tris{2-methyl-4-[3-(3,5-di-t-butyl-4-hydroxyphenyl)propionyloxy]-5-t-butyl phenyl}butane;
(iii) 1,3,5-trimethyl-2,4,6-tris(3,5-di-t-butyl-4-hydroxybenzyl)benzene;
(iv) tris(3,5-di-t-butyl-4-hydroxybenzyl)isocyanurate; and
(v) 4,4′-butylidenebis-(3-methyl-6-t-butylphenol).
